(19) United States
(12) Patent Application Publication
(10) Pub. No.: US 2024/0100659 A1
(43) Pub. Date: Mar. 28, 2024

(54) Wrenches

(71) Applicant: Milwaukee Electric Tool Corporation, Brookfield, WI (US)

(72) Inventors: Lucy Seokyung Cho, Rolling Meadows, IL (US); Benjamin J. Paprocki, Cottage Grove, WI (US); Jedidiah J. Babinec, Milwaukee, WI (US); Aaron S. Blumenthal, Shorewood, WI (US)

(21) Appl. No.: 18/451,618

(22) Filed: Aug. 17, 2023

Related U.S. Application Data
(60) Provisional application No. 63/383,189, filed on Nov. 10, 2022.
(60) Provisional application No. 63/377,430, filed on Sep. 28, 2022.

(51) Int. Cl. B25B 23/00; B25B 13/48

(52) U.S. Cl. CPC B25B 23/0028; B25B 13/481; B25B 13/5058

(57) ABSTRACT

Various embodiments of a hand tool shown as wrenches are provided. In some embodiments the wrenches include adjustable heads that allow for use within the small spaces such as around plumbing fixtures. Certain embodiments include a head with a fixed jaw and a moveable jaw such that the wrenches may be used with workpieces of various dimensions.

### CROSS-REFERENCE TO RELATED PATENT APPLICATIONS

The present application claims the benefit of and priority to U.S. Provisional Application No. 63/383,189, filed on Nov. 10, 2022, and to U.S. Provisional Application No. 63/377,430 filed on Sep. 28, 2022, which are incorporated herein by reference in their entireties.

### BACKGROUND OF THE INVENTION

The present disclosure is directed generally to the field of hand tools. The present disclosure relates specifically to various wrench designs.

### SUMMARY OF THE INVENTION

One embodiment of the invention relates to an adjustable wrench including a handle and a head. The handle includes an engagement end and a gripping end. The handle extends between the gripping end and the engagement end along a longitudinal axis of the handle. The head is coupled to the engagement end of the handle. The head includes a fixed jaw and an adjustable jaw extending away from the fixed jaw. The adjustable wrench further includes an adjustment mechanism positioned between the engagement end of the handle and the adjustable jaw and a pivot axis. The adjustment mechanism engages a rear portion of the adjustable jaw. The pivot axis perpendicular to the longitudinal axis. When the handle is pivoted about the pivot axis, the engagement end of the handle moves the adjustment mechanism such that the adjustable jaw is moved relative to the fixed jaw.

Another embodiment of the invention relates to a wrench including a handle and a head. The handle includes a first end and a second end. The handle extends between the first end and the second end along a longitudinal axis of the handle. The head is coupled to the first end of the handle. The head includes a fixed jaw including a first jaw face and a moveable jaw including a second jaw face. The second jaw face extends away from the first jaw face. The wrench further includes a screw drive engaged with the moveable jaw, a carriage that holds the screw drive, and a pivot axis. The pivot axis is perpendicular to longitudinal axis of the handle. When the handle is pivoted about the pivot axis, the first end of the handle moves the screw drive such that the moveable jaw is moved relative to the fixed jaw.

Another embodiment of the invention relates to a self-adjusting wrench including a handle and a head. The handle includes an engagement end and a gripping end. The handle extends between the gripping end and the engagement end along a longitudinal axis of the handle. The head is coupled to the engagement end of the handle. The head includes a fixed jaw and an adjustable jaw extending away from the fixed jaw. The adjustable jaw includes a threaded section. The self-adjusting wrench further includes a screw drive including threads and a carriage. The screw drive is engaged with the threaded section of the adjustable jaw. The carriage holds the screw drive. When the handle is pivoted, the engagement end of the handle interfaces against the carriage and rotates the screw drive such that the adjustable jaw is moved relative to the fixed jaw.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a wrench, according to an exemplary embodiment.

FIG. 2 is a perspective view of the wrench of FIG. 1 with a head pivoted in a first direction, according to an exemplary embodiment.

FIG. 3 is a perspective view of the wrench of FIG. 1 with the head pivoted in a second direction, according to an exemplary embodiment.

FIG. 4 is a perspective view of the wrench of FIG. 1 with the head pivoted in a third direction, according to an exemplary embodiment.

FIG. 5 is a partially exploded view of the wrench of FIG. 1, according to an exemplary embodiment.

FIG. 6 is an exploded view of the wrench of FIG. 1, according to an exemplary embodiment.

FIG. 7 is a right perspective view of a wrench, according to another exemplary embodiment.

FIG. 8 is a left perspective view of the wrench of FIG. 7, according to an exemplary embodiment.

FIG. 9 is a cross-sectional view taken along line 9-9 of FIG. 7, according to an exemplary embodiment.

FIG. 10 is a right side view of the wrench of FIG. 7 with a transparent handle, according to an exemplary embodiment.

FIG. 11 is a perspective view of a wrench, according to another exemplary embodiment.

FIG. 12 is a perspective view of the wrench of FIG. 11 with a portion of the handle removed, according to an exemplary embodiment.

FIG. 13 is a detailed perspective view of a locking portion the wrench of FIG. 11, according to an exemplary embodiment.

FIG. 14 is a perspective view of a wrench, according to another exemplary embodiment.

FIG. 15 is side view of the wrench of FIG. 14 in a first, closed position, according to an exemplary embodiment.

FIG. 16 is a side view of the wrench of FIG. 14 in a second, open position, according to an exemplary embodiment.

FIG. 17 is a cross-sectional view taken along line 17-17 of FIG. 14, according to an exemplary embodiment.

FIG. 18 is a perspective view of a wrench, according to another exemplary embodiment.

FIG. 19 is an exploded view of the wrench of FIG. 18, according to an exemplary embodiment.

FIG. 20 is a cross-sectional view taken along line 20-20 of FIG. 18, according to an exemplary embodiment.

FIG. 21 is a perspective view of a wrench, according to another exemplary embodiment.

FIG. 22 is a perspective view of the wrench of FIG. 21 with driving tools in an open position, according to an exemplary embodiment.

FIG. 23 is a partially exploded perspective view of the wrench of FIG. 21 with a handle and a cover of the head rotated, according to an exemplary embodiment.

FIG. 24 is a side view of the head of the wrench of FIG. 21 in a first, closed position, according to an exemplary embodiment.

FIG. 25 is a side view of the head of the wrench of FIG. 21 in a second, open position, according to an exemplary embodiment.

FIG. 26 is a cross-sectional view taken along line 26-26 of FIG. 24, according to an exemplary embodiment.

FIG. 27 is a cross-sectional view taken along line 27-27 of FIG. 25, according to an exemplary embodiment.

FIG. 28 is a partially exploded perspective view of a wrench, according to another exemplary embodiment.

FIG. 29 is an exploded view of the wrench of FIG. 28 with the driving tool set removed, according to an exemplary embodiment.

FIG. 30 is a detailed perspective view of a head of the wrench of FIG. 28 in a first, closed position, according to an exemplary embodiment.

FIG. 31 is a detailed perspective view of a head of the wrench of FIG. 28 in a second, open position, according to an exemplary embodiment.

### DETAILED DESCRIPTION

Referring generally to the figures, various embodiments of wrenches, such as plumbing wrenches, flush valve wrenches, etc. are provided. As discussed herein, Applicant has developed a number of improvements to wrenches. In contrast to the various wrenches discussed herein, many wrenches may have difficulty being maneuvered or turned within the small spaces such as around plumbing fixtures (e.g., under sinks, close to walls or other plumbing fixtures). In a specific embodiment, Applicant has designed a wrench with one or more pivotable joints that allow the head of the wrench to move in four directions (i.e., towards a user, away from a user, clockwise, and counterclockwise). Applicant believes the pivotable head discussed herein allows for use in compact spaces (e.g., under sinks, close to walls or other plumbing fixtures) that may otherwise make it difficult to access a workpiece (nut, bolt, etc.) and turn the handle of the wrench handle during tightening and/or loosening of the workpiece.

Additionally, in various embodiments, the adjustable wrench includes one or more driving tools, such as a screwdriver stored within the body of the wrench or coupled to the handle of the wrench. Combining the functionality of a driving tool (tightening and/or loosening screws, etc.) with a wrench in a single tool reduces the number of tools a worker needs to carry and/or interact with, thereby increasing the efficiency of the worker. The combined functionality is useful for plumbers or utility workers who work in environments where it may be difficult to carry around a large number of tools or reach another tool while working (i.e., when under a sink).

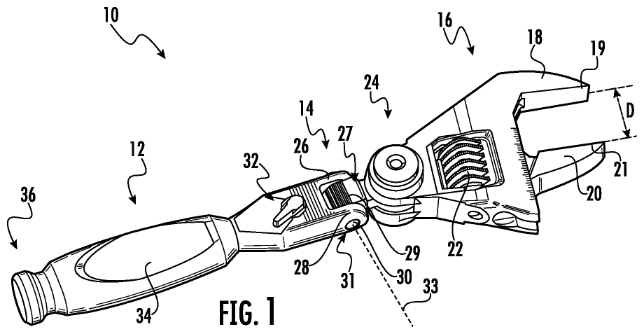

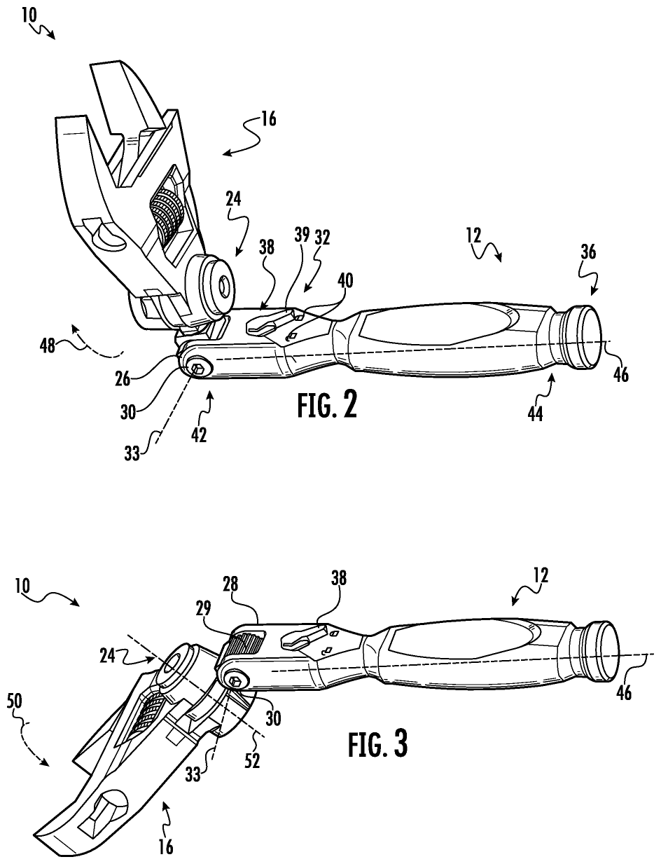

Referring to FIG. 1, various aspects of a wrench 10 with an adjustable wrench head 16 are shown. Wrench 10 includes a shank or handle 12 extending from wrench head 16 along a longitudinal axis 46 (see e.g., FIG. 2). Wrench 10 includes a first pivot joint 14. In general, first pivot joint 14 is positioned between handle 12 and wrench head 16 and allows the user to change the angular position of wrench head 16 relative to handle 12. Wrench head 16 includes a fixed jaw 18 and an adjustable or moveable jaw 20. An adjusting screw or thumbwheel 22 moves the adjustable jaw 20 toward and/or away from fixed jaw 18.

The adjustability of wrench head 16 allows a user to tighten and loosen a variety of workpieces with various dimensions or diameters. Fixed jaw 18 includes a jaw surface or face 19 and adjustable jaw 20 includes a jaw surface of face 21. An adjustable distance D is defined between jaw surface 19 and jaw surface 21. In a specific embodiment, D is between 0 and 2.5 inches.

Wrench head 16 further includes a second pivot joint 24. As will be discussed in greater detail below, second pivot joint 24 allows wrench head 16 to move in a clockwise and/or counterclockwise direction while first pivot joint allows wrench head 16 to move upwards (i.e., towards the user) and downwards (i.e., away from the user).

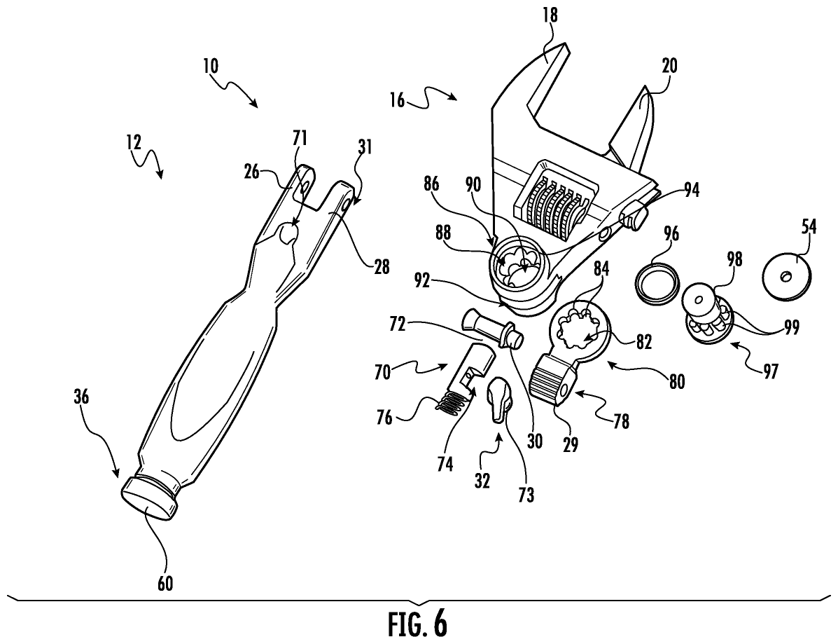

Wrench 10 includes flanges or arms 26 and 28 located at an engagement end of handle 12, positioned proximate or adjacent to wrench head 16. Wrench head 16 is coupled to a connector 27 that includes a toothed projection 29. Toothed projection 29 is positioned between arms 26 and 28. An axle or pin 30 extends through openings 31 that extend through each arm 26, 28. Pin 30 similarly extends through a channel 78 (see e.g., FIG. 6) in toothed projection 29 and specifically a channel 78 (see e.g., FIG. 6) in toothed projection 29 such that pin 30 rotatably couples wrench head 16 to handle 12.

Wrench 10 includes a locking mechanism 32 that allows the user to selectably and reversibly lock wrench head 16 in a desired angular position relative to the handle 12. Locking mechanism 32 is moveable between a locked position in which the angular position of wrench head 16 relative to handle 12 is fixed and an unlocked position in which wrench head 16 is pivotable about pivot joint 14 and specifically about a first pivot axis 33 defined by pivot joint 14. Pin 30 extends along first pivot axis 33. First pivot axis 33 extends in a generally perpendicular direction (i.e., 90 degrees plus or minus 10 degrees) to longitudinal axis 46 when wrench 10 is not pivoted about first pivot joint 14 (i.e., when head 16 is at a zero angle position).

Handle 12 includes a grip surface 34. In a specific embodiment, grip surface 34 includes a planar or flat surface. Applicant believes having a planar grip surface with a large width relative to a total width of the handle creates an ergonomic grip. As will be discussed in greater detail below, wrench 10 includes a driving tool, shown as a screwdriver 36 stored within the handle 12 of the wrench 10.

Referring to FIGS. 2-3, perspective views of wrench 10 are shown with wrench head 16 in pivoted positions, according to an exemplary embodiment. In general, locking mechanism 32 includes an engagement member, shown as shuttle 70 (see e.g., FIG. 6) and a control mechanism 38. When a user moves control mechanism 38 to a locked position (as shown in FIG. 2), shuttle 70 engages tooth projection 29, locking wrench head 16 in a desired angular position. Then when a user moves control mechanism 38 to an unlocked position, shuttle 70 disengages from toothed projection 29, allowing wrench head 16 to freely pivot about pin 30. Control mechanism 38 includes an actuator, shown as switch 39. In a specific embodiment, a surface of handle 12 includes at least one visual indicator 40 of the status of the locking mechanism 32. In such an embodiment, the visual indicator 40 is at least one of an open and a closed lock symbol that switch 39 of the control mechanism 38 points to indicate to a user the status of the locking mechanism 32.

Handle 12 includes a first end 42, proximal or adjacent to wrench head 16 and first pivot axis 33 and a second end 44 that opposes first end 42 and is distal to wrench head 16. A longitudinal axis 46 of handle 12 extends between first end 42 and second end 44. When wrench 10 has wrench head 16 in an unpivoted position, longitudinal axis 46 of handle 12 is a longitudinal axis of wrench 10.

When locking mechanism 32 is in an unlocked position, wrench head 16 is pivotable about pivot joint 14 in a first, upward direction (i.e., toward a user, see FIG. 2), shown by arrow 48. Wrench head 16 can also be pivoted about pivot joint 14 in a second, downward direction (i.e., away from a user, see FIG. 3), shown by arrow 50. When wrench head 16 is pivoted in the first direction 48 or second direction 50, wrench head 16 moves from being aligned (i.e., longitudinal axis of wrench head 16 is collinear with longitudinal axis 46) to angled relative to longitudinal axis 46 of handle 12.

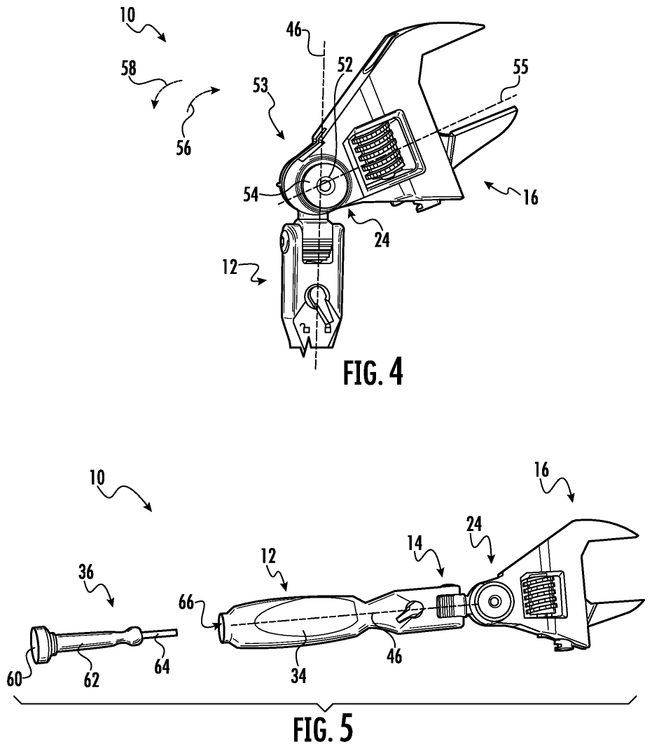

Referring to FIG. 4, a perspective view of wrench 10 is shown with wrench head 16 in a third pivoted position, according to an exemplary embodiment. Second pivot joint 24 of wrench 10 includes an actuator 54 and defines a second pivot axis 52. Second pivot axis 52 extends in a generally perpendicular direction (i.e., 90 degrees plus or minus 10 degrees) to longitudinal axis 46 when wrench 10 is not pivoted about first pivot joint 14 (i.e., when head 16 is at a zero angle position). Second pivot axis 52 is nonparallel to first pivot axis 33. In a specific embodiment, second pivot axis is generally perpendicular (i.e., 90 degrees plus or minus 10 degrees) to first pivot axis 33 when wrench 10 is not pivoted about first pivot joint 14 (i.e., when head 16 is at a zero angle position). In general, second pivot joint 24 is positioned between handle 12 and wrench head 16 and more specifically between first pivot joint 14 and wrench head 16. Second pivot joint 24 allows the user to change the angular position of wrench head 16 relative to handle 12.

Second pivot joint 24 has a second pivot locking mechanism 53 separate from locking mechanism 32. When locking mechanism 53 is in an unlocked position, wrench head 16 is pivotable about second pivot joint 24 in a third, clockwise direction (see e.g., FIG. 4), shown by arrow 56 such that a longitudinal axis 55 of wrench head 16 is no longer parallel to longitudinal axis 46. Wrench head 16 can also be pivoted about second pivot joint 24 in a fourth, counterclockwise direction, shown by arrow 58 (opposite direction from third direction). When wrench head 16 is pivoted in the third direction 56 or fourth direction 58, wrench head 16 moves from being aligned (i.e., longitudinal axis 55 of wrench head 16 is collinear with longitudinal axis 46) to angled relative to longitudinal axis 46 of handle 12.

Referring to FIG. 5, a partially exploded view of wrench 10 is shown, according to an exemplary embodiment. Wrench 10 includes a removable screwdriver 36 stored within handle 12. Screwdriver 36 includes a body extending between an end surface 60 that is the most distal portion of handle 12 when wrench 10 is assembled and a tool bit, shown as flat head bit 64. Handle 12 of wrench 10 includes a bore 66 leading to an internal cavity configured to receive screwdriver 36. Bore 66 extends along longitudinal axis 46 of handle 12.

Referring to FIG. 6, an exploded view of wrench 10 is shown, according to an exemplary embodiment. Locking mechanism 32 includes shuttle 70 which includes an engagement portion shown as teeth 72 configured to engage with toothed projection 29 and a biasing element, shown as spiral spring 76. Control mechanism 38 further includes a shaft 73 coupled to and extending from switch 39. Various components of locking mechanism 32 and control mechanism 38 are located within a cavity 71 of handle 12. When assembled with shuttle 70, shaft 73 is located within an open section 74 of shuttle 70. Engagement and/or disengagement between shaft 73 and shuttle 70 changes with movement of switch 39.

When switch 39 is rotated into the locked position, spring 76 is allowed to expand pushing teeth 72 into engagement with toothed projection 29 such that wrench head 16 is locked in the place selected by the user. When switch 39 is rotated into the unlocked position, shaft 73 engages with shuttle 70 such that spring 76 is compressed and shuttle 70 is pushed away from toothed projection such that teeth 72 are disengaged from toothed projection 29. In this disengaged or unlocked position, wrench head 16 is allowed to freely rotate about pin 30 such that the user can select the desired angular position of wrench head 16.

Second pivot joint 24 includes a link 86. Link 86 includes first aperture 88 and second aperture 90 with gap or space 92 positioned between apertures 88, 90. Apertures 88, 90 each include recesses 94. In a specific embodiment, recesses 94 are arcuate shaped and spaced around a perimeter of apertures 88, 90. In the illustrated embodiment, each aperture 88, 90 includes eight recesses 94. In other embodiments, apertures 88, 90 can include fewer or more than eight recesses 94 around the perimeter.

Connector 27 further includes an end portion 80 having an aperture 82 that extends through end portion 80. End portion 80 is positioned at the opposite end of connector 27 from toothed projection 29. End portion 80 is received in gap 92 of link 86 when connector 27 is assembled with wrench head 16 (see e.g., FIG. 1). Aperture 82 includes recesses 84. In a specific embodiment, recesses 84 are arcuate shaped and spaced around a perimeter of aperture 82. In the illustrated embodiment, aperture 82 includes eight recesses 84. In other embodiments, aperture 82 can include fewer or more than eight recesses 84 around the perimeter. Recesses 84 of connector 27 are the same shape as recesses 94 of link 86.

Locking button 97 extends through apertures 88, 90 of link 86 and aperture 82 of connector 27. Locking button 97 locks link 86 and handle 12 together for movement to operate wrench head 16 to grip a workpiece. Locking button 97 can be actuated along second pivot axis 52 by pushing actuator 54 which pushes locking button 97 along second pivot axis 52 to allow the user to rotate handle 12 relative to link 86 to adjust the angle of wrench head 16. Locking button 97 includes a set of shoulders 99. The shoulders 99 are arcuate shaped and sized to be removably received in the recesses 94 of the link 86 and the recesses 84 of connector 27. That is, the shoulders 99 can slide into and out of the recesses 84, 94. Shoulders 99 protrude past a base surface, shown as a curved base surface 98 of locking button 97. Base surface 98 encircles second pivot axis 52. A biasing element, shown as spring 96 is positioned between locking button 97 and actuator 54. Spring 96 biases locking button 97 along the second pivot axis 52 to a position in which the shoulders 99 interface against the recesses 94 of the first and second apertures 88, 90.

When second pivot joint 24 is in the locked position, shoulders 99 of locking button 97 are received in recesses 94 of second aperture 90 of link 86, recesses 94 of first aperture 88 of link 86 and recesses 84 of aperture 82 of connector 27. In this position, locking button 97 couples handle 12 to wrench head 16 via connector 27 in a fixed manner, allowing for use of wrench head 16 to grip a workpiece. If the user would like to rotate wrench head 16 in a counterclockwise 58 or clockwise direction 56, the user pushes actuator 54 to acuate locking button 97 in a downward direction (i.e., toward second aperture 90) to move locking button 97 along second pivot axis 52 relative to link 86 and handle 12. This movement causes shoulders 99 to move out of recesses 94 of first aperture 88 and recesses 84 of connector 27 such that shoulders are engaged only with recesses 94 of second aperture 90. Therefore, base surface 98 is adjacent to recesses 94 of first aperture 88 and recesses 84 of aperture 82 of connector 27. The position of locking button 97 allows a user to rotate handle 12 or wrench head 16 about second pivot axis 52. When handle 12 and/or wrench head 16 is at the desired position, locking button 97 is moved back to the engaged or locked position.

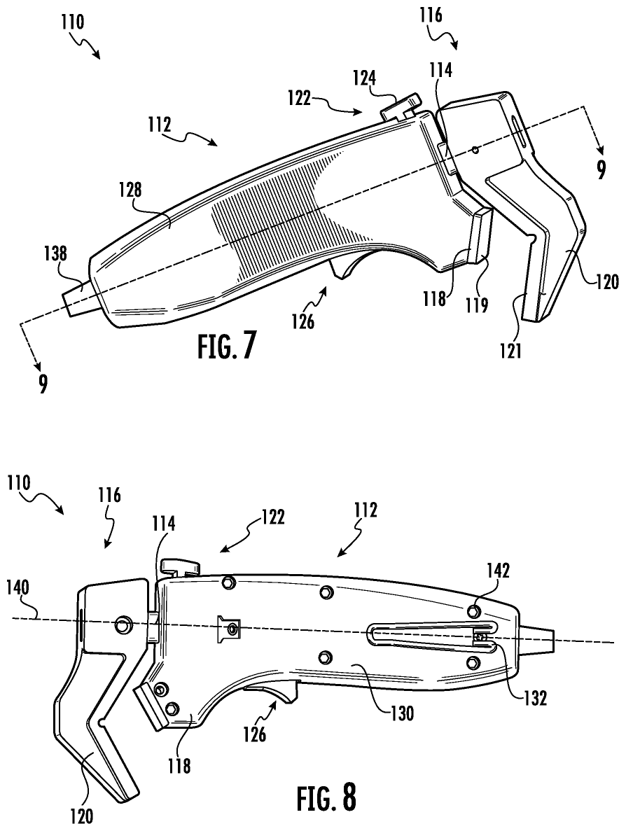

Referring to FIGS. 7-10, various views of a wrench shown as a bar clamp wrench 110 are shown, according to an exemplary embodiment. Bar clamp wrench 110 includes a body 112, a bar 114, and a head 116. Body 112 includes an upper housing 128 and a lower housing 130. In various embodiments, body 112 is a continuous and/or integral part such that upper housing 128 and lower housing 130 are permanently joined and/or fabricated as a unitary part. In other embodiments, upper housing 128 and lower housing 130 are coupled to form body 112 using fasteners 142. In a specific embodiment, body 112 is formed from a polymer. In a specific embodiment, a belt or pocket clip 132 is coupled to body 112.

Bar clamp wrench 110 includes and specifically head 116 includes a fixed jaw 118 and an adjustable or moveable jaw 120. When bar 114 moves the adjustable jaw 120 moves toward and/or away from fixed jaw 118. The adjustability of head 116 allows a user to tighten and loosen a variety of workpieces 160 with various dimensions. Fixed jaw 118 includes a jaw surface or face 119 and moveable jaw 120 includes a jaw surface of face 121. An adjustable distance D2 is defined between jaw surface 219 and jaw surface 121. In a specific embodiment, D2 includes a range such that workpieces from a ¾ inch nut to a 2⅜ inch nut can be grasped by head 116.

Bar 114 extends along a longitudinal axis 140 of bar clamp wrench 110 between a first end 134 and a second end 136. First end 134 of bar 114 is coupled to moveable jaw 120. Second end 136 of bar extends through body 112 and can project out an exit opening 137. Bar 114 includes a flat blade screwdriver 138 at second end 136.

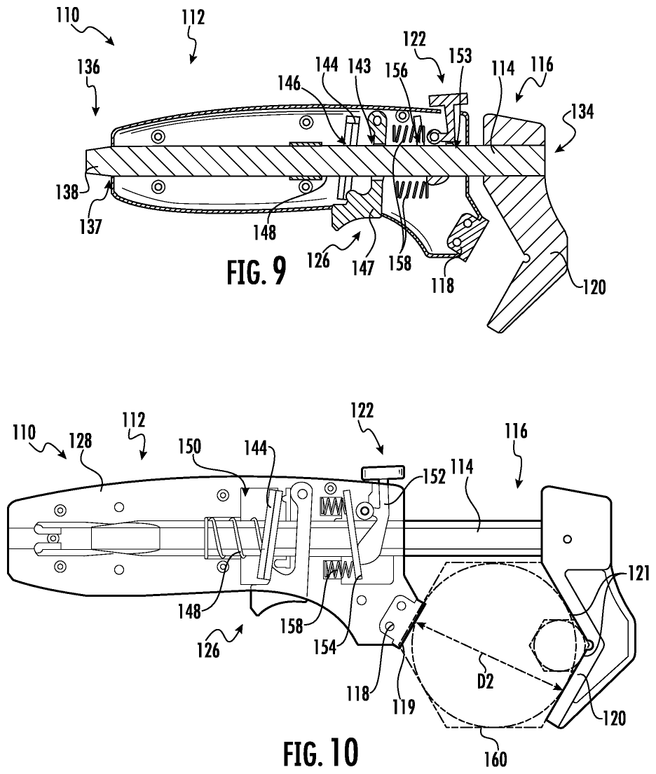

Referring to FIGS. 9-10, details of various head 116 adjustment components are shown, according to an exemplary embodiment. A bar lock release 122 is coupled to body 112 near first end 134 of bar 114. Bar lock release 122 includes an engagement surface 124 that a user may press to release the bar 114 from a locked position. When bar lock release 122 is pressed, a user can slide bar 114 and moveable jaw 120 freely (i.e., to make large adjustments). Final tightening or fine adjustments of moveable jaw 120 are performed using a trigger 126.

Trigger 126 include an arm 147 that extends within body 112. Arm 147 includes a channel 143 that extends through arm 147 such that bar 114 passes through arm 147. Trigger 126 engages a drive lever 144. Drive lever 144 includes a channel 146 extending through the drive lever 144 such that bar 114 passes through drive lever 144. Drive lever 144 is positioned within a cavity 150 in body 112. A biasing element, shown as a spring 148 is positioned in cavity 150 and around bar 114.

When trigger 126 is squeezed (i.e., pressed toward body 112) the trigger 126 engages drive lever 144 and presses drive lever 144 back (i.e., in direction toward second end 136 of bar 114) causing bar 114 to move back. When bar 114 moves back or toward exit opening 137 of body 112, moveable jaw 120 moves toward fixed jaw 118. As bar 114 is moving, spring 148 is compressed. When the trigger 126 is released, spring 148 engages drive lever 144 and provides a biasing force to move drive lever 144 back to a starting position. The process of pressing and releasing trigger 126 is repeated until a user has adjusted moveable jaw 120 to fit and grasp a workpiece of their choice.

As previously mentioned, when bar lock release 122 is pressed, a user can slide bar 114 and moveable jaw 120 freely. Bar lock release 122 includes an engagement arm 152. Engagement arm 152 includes a channel 153 that extends through arm 152 such that bar 114 passes through engagement arm 152. When bar lock release 122 is pressed (i.e., moved toward body 112) arm 152 engages or presses a release lever 154. Release lever 154 includes a channel 156 that bar 114 extends through. One or more biasing elements, shown as springs 158 are positioned within body 112 to engage release lever 154.

When engagement arm 152 presses release lever 154, the release lever 154 moves from an angled position in which the channel 156 walls engage bar 114 to hold or lock bar 114 in place. Drive lever 144 in the unlocked position is positioned in a generally perpendicular (i.e., 90 degrees plus or minus 10 degrees) orientation to longitudinal axis 140 of bar clamp wrench 110, allowing bar 114 to slide through channel 156 and move within body 112. When the bar lock release 122 is reengaged, one or more springs 158 engage release lever 154 and provides a biasing force to move release lever 154 back to an angled or locked position.

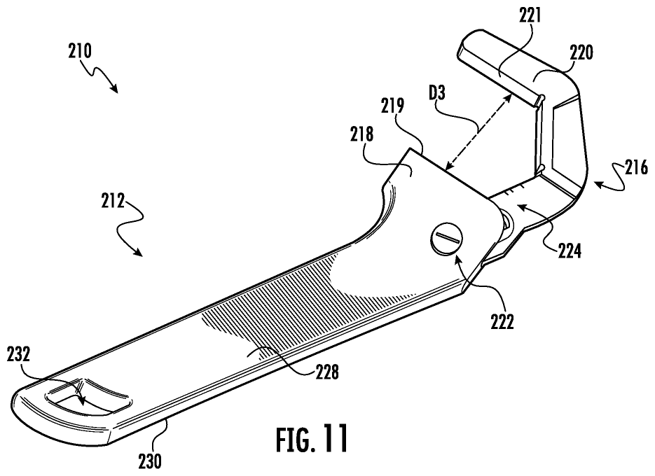

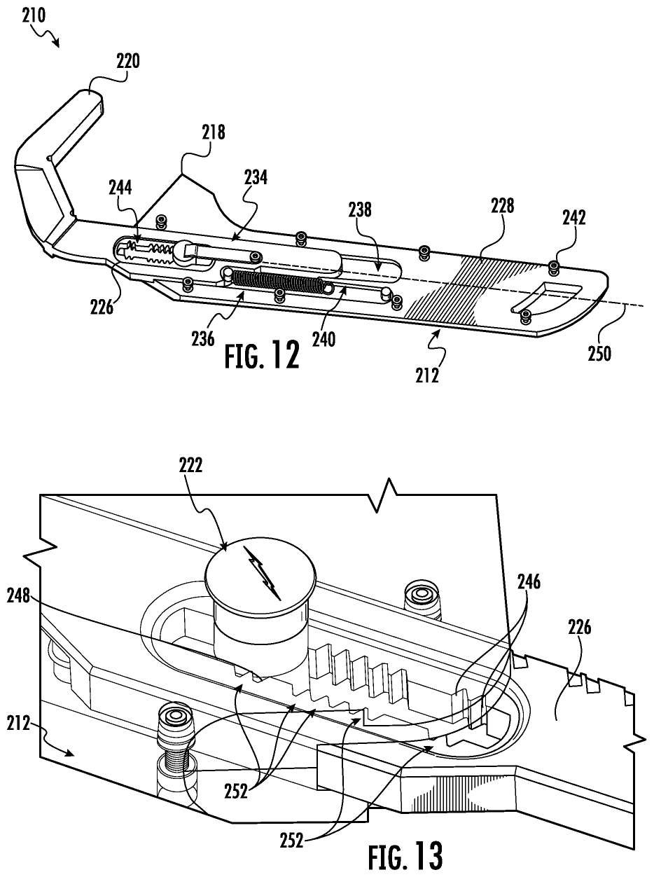

Referring to FIGS. 11-13, various views of a wrench shown as a hex wrench 210 are shown, according to an exemplary embodiment. Hex wrench 210 includes a handle 212 and a head 216. Handle 212 includes an upper housing 228 and a lower housing 230. In a specific embodiment, upper housing 228 and lower housing 230 are coupled to form body 212 using fasteners 242 (see e.g., FIG. 12). In a specific embodiment, body 212 is formed from a polymer. In a specific embodiment, body 212 includes a hole or opening 232 extending through body 212 that allows for tethering hex wrench 210.

Head 216 includes a fixed jaw 218 and an adjustable or moveable jaw 220. The adjustability of head 216 allows a user to tighten and loosen a variety of workpieces with various diameters and the use of a spring loaded mechanism allows for efficient adjustment of head 216. Moveable jaw 220 is connected to a neck 226 that extends into handle 212. When a user presses a release button 222 to adjusts hex wrench 210 for a specific workpiece, the moveable jaw 220 moves toward and/or away from fixed jaw 218. Fixed jaw 218 includes a jaw surface or face 219 and moveable jaw 220 includes a jaw surface of face 221. An adjustable distance D3 is defined between jaw surface 219 and jaw surface 121. In a specific embodiment, D3 includes a range such that workpieces from a 1.15-inch nut to a 2-inch nut can be grasped by head 216. In a specific embodiment, a surface of handle moveable jaw 220 includes at least one visual indicator 224 to indicate the position of moveable jaw 220.

Referring to FIG. 12, a perspective view of hex wrench 210 with lower housing 230 removed is shown. Handle 212 includes a channel 238 configured to receive neck 226 and a biasing channel 240 that is configured to receive a biasing element, shown as jaw spring 236. A lock spring 234 is coupled to release button 222 and extends outside of lower housing 230 when hex wrench 210 is assembled. Neck 226 extends along a longitudinal axis 250 of hex wrench 210 and includes a longitudinally extending channel 244.

Referring to FIG. 13, a detailed perspective view of the locking mechanism of hex wrench 210 is shown, according to an exemplary embodiment. Channel 244 includes a plurality of teeth 246. Channel teeth 246 are positioned along a perimeter of channel 244 in various locations and are configured to engage with opposing teeth 248 of release button 222. When teeth 248 engage or interface against teeth 246 of channel 244, head 216 and moveable jaw 220 are locked in place. When release button 222 is pressed, teeth 248 move out of engagement with channel teeth 246 such that moveable jaw 220 is slidable and/or moveable along longitudinal axis 250 to adjust the distance between moveable jaw 220 and fixed jaw 218. Channel 244 includes various discrete locking locations 252.

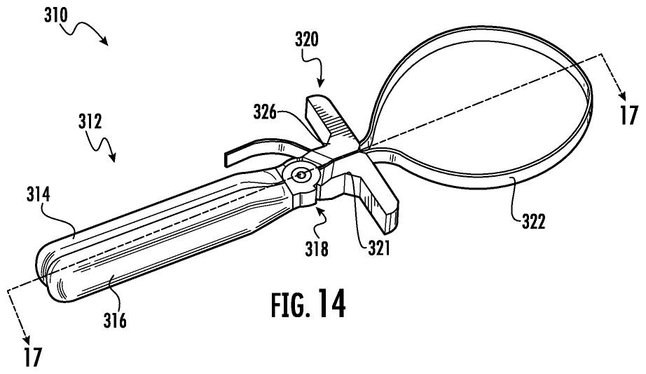

Referring to FIGS. 14-17, various views of a wrench shown as a strap wrench 310 are shown, according to an exemplary embodiment. Strap wrench 310 includes a handle 312 and a strap 322. In a specific embodiment, strap 322 is formed from a rubber material. Handle 312 include a first or upper handle 314 and a second or lower handle 316. In a specific embodiment, first and second handles 314, 316 are formed from a polymer material.

First handle 314 and second handle 316 are coupled at a hinge 318. In a specific embodiment, hinge 318 is spring loaded. Each handle 314, 316 includes a neck portion 320 positioned between hinge 318 and strap 322. When strap wrench 310 is assembled, hinge 318 and neck 320 are formed by first handle 314 and second handle 316 crossing over each other such that first handle 314 is connected to a lower portion 321 of neck 320 and second handle 316 is connected to an upper portion 326 of neck 320.

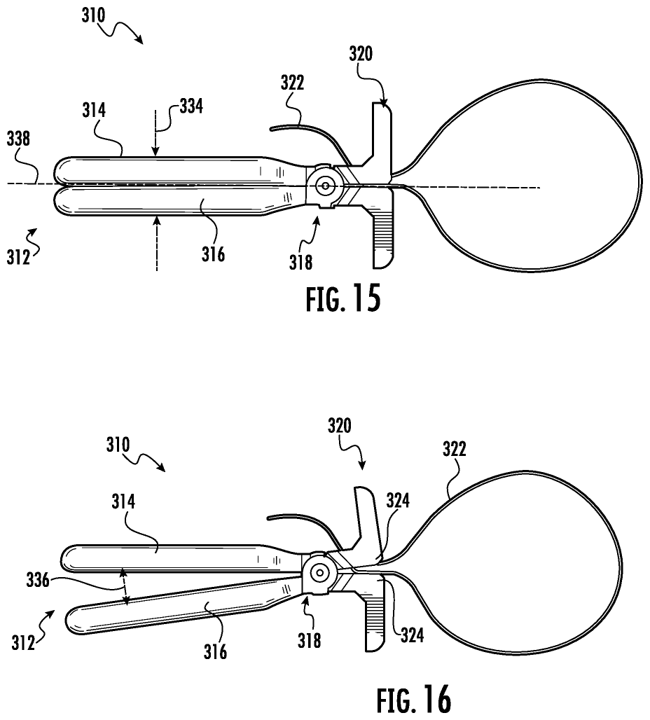

Referring to FIGS. 15-16, side views of strap wrench 310 are shown in a first, closed position and a second, open position respectively. When a user is ready to engage a workpiece (i.e., tighten, loosen, etc.) with strap wrench 310, they push handles 314, 316 in an inward direction, shown by arrow 334 towards a longitudinal axis 338 of strap wrench 310. In the closed position, strap 322 is pinched such that strap 322 is locked in place. When a user is finished, handles 314, 316 can be pulled in an outward direction, shown by arrow 336, away from longitudinal axis 338, releasing strap 322 so it is unlocked or adjustable.

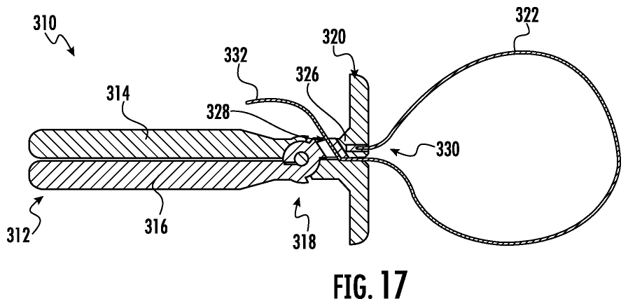

Referring to FIG. 17, a cross-sectional view of strap wrench 310 taken along line 17-17 of FIG. 14 is shown, according to an exemplary embodiment. Strap 322 includes a first end 330 coupled to neck 320 and a second end 332 that is a free or adjustable end. Upper portion 326 of neck 320 includes a channel 328 extending through upper portion 326. Second end 332 of strap 322 extends through channel 328 and can be pulled through channel 328 to tighten or reduce the dimension of strap 322. Neck 320 includes a pair of opposing engagement surface 324 (see e.g., FIG. 16). When strap wrench 310 is in the open position, a gap or space exists between engagement surfaces 324, allowing strap 322 to be loosened or tightened. When strap wrench is in the closed position, opposing engagement surfaces 324 engage both sides of strap 322 such that strap 322 is pinched or squeezed and held in place.

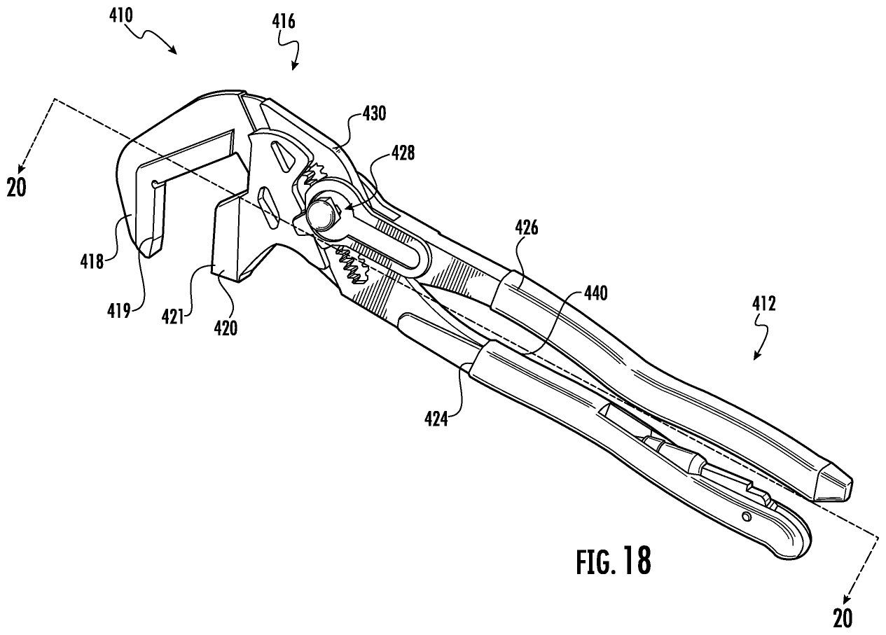

Referring to FIGS. 18-20 various views of a wrench shown as a pliers wrench 410 are shown, according to an exemplary embodiment. Pliers wrench 410 includes a head 416 and a handle 412 that includes a first or lower handle 424 and a second or upper handle 426. Head 416 includes a fixed jaw 418 and an adjustable or moveable jaw 420. First handle 424 and second handle 426 generally extend along a longitudinal axis 440 of pliers wrench 410.

The adjustability of head 416 allows a user to tighten and loosen a variety of workpieces with various diameters. Moveable jaw 420 is connected to a neck 430 that extends into first handle 424. Specifically, movable jaw 420 is coupled to first handle 424 and second handle 426 by an actuation mechanism 428. Fixed jaw 418 includes a jaw surface or face 419 and moveable jaw 420 includes a jaw surface of face 421. Fixed jaw 418 and moveable jaw 420 are designed to move in parallel such that jaw face 419 and jaw face 421 maintain parallel orientations due to actuation mechanism 428.

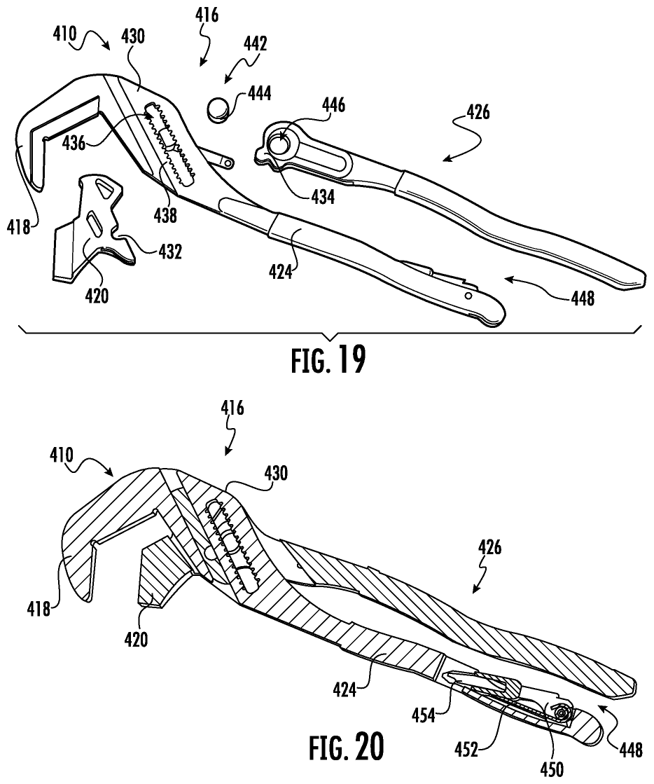

Referring to FIGS. 19-20 details of head 416 adjustment mechanism and actuation mechanism 428 are shown, according to an exemplary embodiment. Neck 430 extends along an elongated opening 436. Elongated opening 436 includes a plurality of ridges or teeth 438. Teeth 438 are positioned along a perimeter of elongated opening 436 and configured to engage or interface against teeth 444 on pin 442. Pin 442 extends at least partially through elongated opening 436 and a through bore 446 in second handle 426.

When a user wants to adjust head 416, an end of pin 442 is actuated such that teeth 444 move out of engagement with channel teeth 438 and pliers wrench 410 is in an unlocked position. A user can then move second handle 426 relative to first handle 424. A cam 434 on an end of second handle 426 engages a cam surface 432 on moveable jaw 420 to move jaw 420. When head 416 is in the desired position, pin 442 is released such that teeth 444 become reengaged with channel teeth 438 locking head 416 in a new position.

In a specific embodiment, a rotatable tool set 448 is stored within one of the handles 424, 426. In the illustrated embodiment, tool set 448 is positioned within first handle 424. Tool set 448 includes a bit holder 450 with a tool bit, shown as a Philips head tool bit and a hex key 452. In various embodiments, other tool types may be included in the tool set 448.

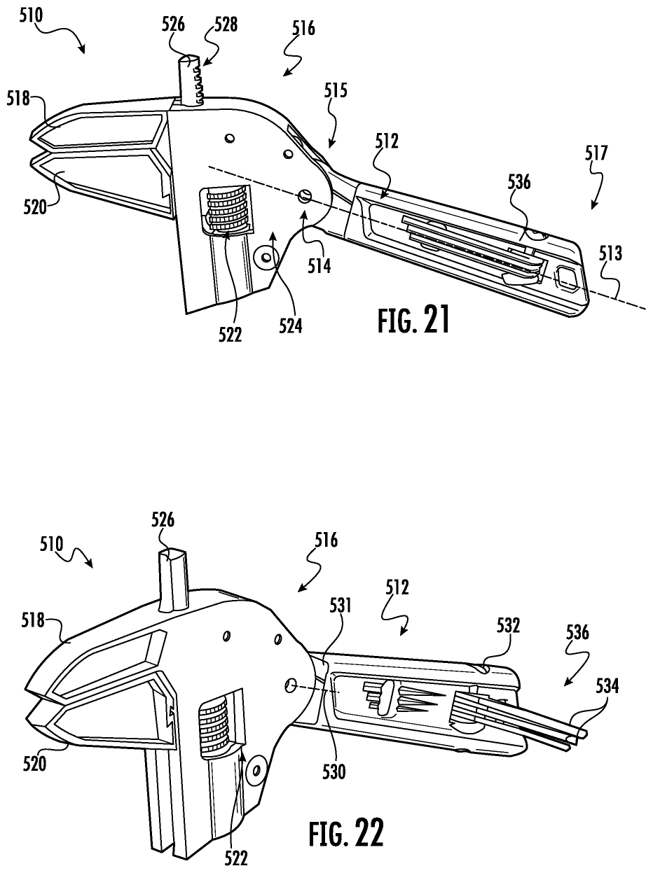

Referring to FIGS. 21-27, various views of a wrench shown as a self-setting adjustable wrench 510 are shown, according to an exemplary embodiment. Self-setting adjustable wrench 510 includes a shank or handle 512 extending from head 516. Handle 512 includes an engagement end 515 and a gripping end 517. Handle 512 extends between the gripping end 517 and the engagement end 515 along a longitudinal axis 513 of handle 512.

Wrench 510 includes a pivot joint 514. Wrench head 516 includes a fixed jaw 518 and an adjustable or moveable jaw 520. In general, pivot joint 514 is positioned between handle 512 and wrench head 516 and allows the user to move handle 512 to change the relative positions of fixed jaw 518 and moveable jaw 520 using an adjustment mechanism 524. As will be discussed in greater detail below, a screw drive 522 moves the adjustable jaw 520 relative to fixed jaw 518 (i.e., toward and/or away from fixed jaw 518). In a specific embodiment, adjustable jaw 520 extends in a generally parallel orientation (i.e., 90 degrees plus or minus 10 degrees) to the fixed jaw 518. In a specific embodiment, adjustable jaw 520 extends away from fixed jaw 518.

Adjustment mechanism 524 allows a user to move wrench head 516 with improved efficiency compared to a conventional adjustable wrench where the threaded screw is adjusted by hand. Similarly, compared to conventional adjustable wrenches that include a push button that must be actuated prior to moving the adjustable jaw, the adjustment mechanism discussed herein allows for jaw adjustment without a user moving their hand towards the wrench head. Applicant believes this difference not only improves efficiency compared to those conventional adjustable wrenches, but also improves the ability to maneuver or adjust the wrench discussed herein within the small spaces around plumbing fixtures (e.g., under sinks, close to walls or other plumbing fixtures) where it may be difficult to reach forward to actuate a button.

The adjustability of wrench head 516 allows a user to tighten and loosen a variety of workpieces with various diameters. Fixed jaw 518 includes a jaw surface or face 519 and adjustable jaw 520 includes a jaw surface or face 521. In a specific embodiment, jaw face 519 extends in a generally parallel orientation (i.e., 90 degrees plus or minus 10 degrees) to jaw face 521.

Adjustable jaw 520 includes a projection 526 that extends in a generally perpendicular orientation (e.g., 90 degrees plus or minus 10 degrees) to jaw face 521. Projection 526 includes a plurality of threads or grooves 528 that face screw drive 522. An adjustable distance D4 is defined between jaw surface 519 and jaw surface 521. In a specific embodiment, D4 is between 0 and 2⅜ inches. In a specific embodiment, adjustment mechanism 524 allows for 2 inches of adjustment. In a specific embodiment, fixed jaw 518 includes indicia or a series of indicia (i.e., markings) such that a user can determine the distance between jaw surface 519 and jaw surface 521.

In a specific embodiment, a rotatable tool set 536 is coupled to handle 512. In the illustrated embodiment, tool set 536 is positioned along a longitudinal axis of handle 512. Tool set 536 includes a rotatable axle or pin 532. A plurality of hand tools, shown as flathead screwdrivers 534 are coupled to pin 532. As shown in FIG. 22, flathead screwdrivers 534 can be rotated away from the storage position along handle 512 for use.

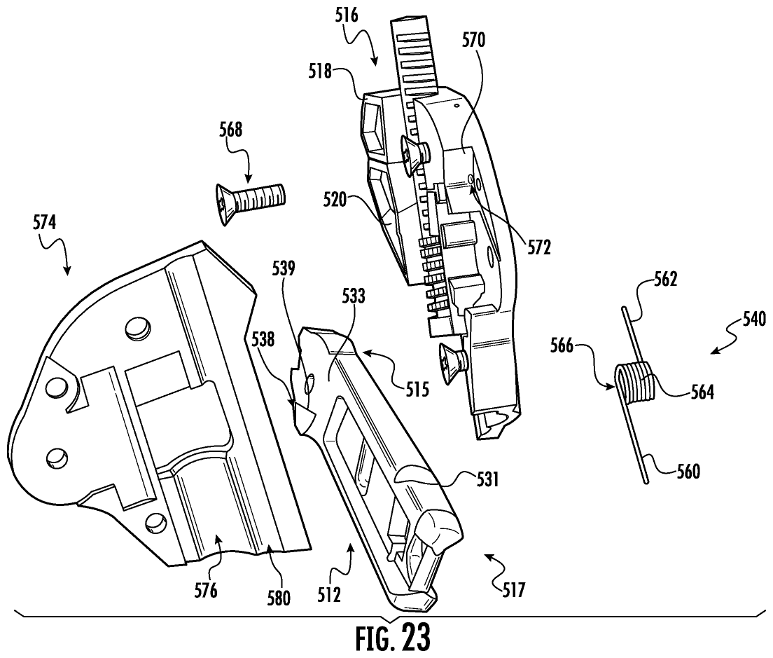

FIG. 23 shows a partially exploded perspective view of wrench 510, according to an exemplary embodiment. Wrench head 516 further includes a cover portion 574 that couples to fixed jaw 518 and/or adjustable jaw 520. As shown in FIG. 23, handle 512 is rotated from the orientation shown in FIGS. 21-22. Handle 512 includes a front side surface 531 and an opposing rear side surface 533. Handle 512 further includes a projection or protrusion 538 on rear side surface 533 at engagement end 515. Projection 538 includes a downward facing (in the orientation shown in FIGS. 21-22) surface 539. Projection 538 and specifically downward facing surface 539 are configured to engage a biasing component, shown as torsion spring 540.

Torsion spring 540 engages the projection 538 on rear surface 533 at the engagement end 515 of handle 512. Torsion spring 540 includes a first arm 560, a second arm 562, and a coil portion 564. The first arm 560 extends in a first direction and the second arm 562 extends in a second direction. In various embodiments, the first direction is different from the second direction. In a specific embodiment, the first direction is opposite from the second direction. Coil portion 564 is positioned between first arm 560 and second arm 562 and includes a coil channel or passageway 566. Coil channel 566 extends through torsion spring 540 and specifically coil portion 564 in an orientation parallel to a pivot axis 530 (see e.g., FIG. 22) of handle 512.

When wrench 510 is assembled, a fastener, shown as screw 568 extends through wrench head 516 with a shaft of screw 568 positioned within coil channel 566 of torsion spring 540. First arm 560 extends rearward (i.e., toward gripping end 517 of handle 512) along rear side surface 533. Specifically, first arm 560 is positioned to engage projection 538 and/or downward facing surface 539 of projection 538 as handle 512 is pivoted. Second arm 562 extends forward (i.e., toward fixed jaw 518) in an opposing direction to first arm 560. Wrench head 516 includes a rear facing, (i.e., toward gripping end 517 of handle 512) biasing wall 570. Coil portion 564 of torsion spring 540 is positioned along rear facing, biasing wall 570. A biasing channel 572 is defined within biasing wall 570. Biasing channel 572 extends at least partially through wrench head 516 toward fixed jaw 518. When wrench 510 is assembled, second arm 562 is positioned within biasing channel 572. In a specific embodiment, channel 572 is positioned at an angle relative to the longitudinal axis 513 of handle 512.

Torsion spring 540 is configured to bias handle 512. In a specific embodiment, torsion spring 540 is configured to engage projection 538 on the rear side surface 533 of the engagement end 515 of the handle 512. When the handle 512 is pivoted in a downward direction, the projection 538 of the handle 512 compresses arm 560 of the torsion spring 540. When the handle 512 is pivoted in an upward direction (i.e., opposing downward direction), the projection 538 releases the arm 560 of the torsion spring 540. The torsion spring 540 biases the handle 512 back into a resting position after the rotation of the screw drive 522.

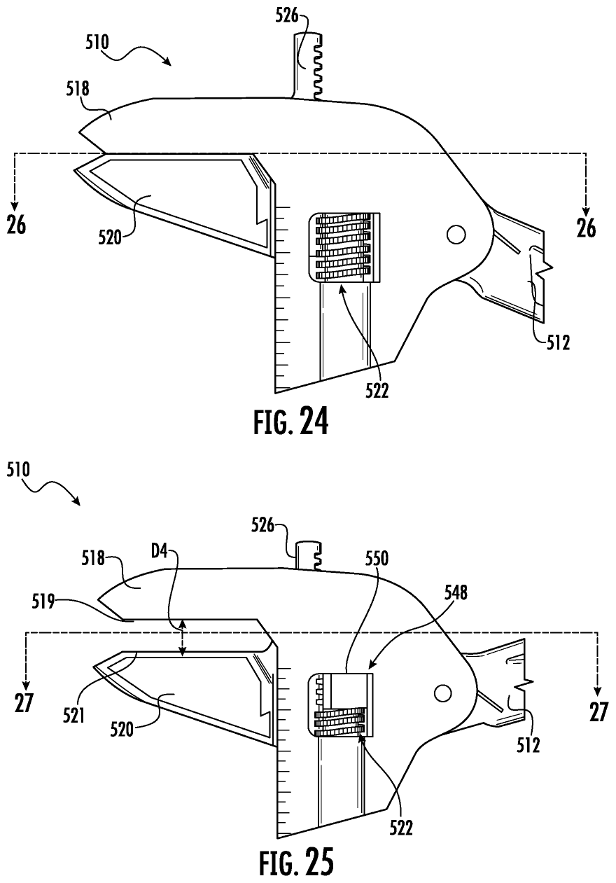

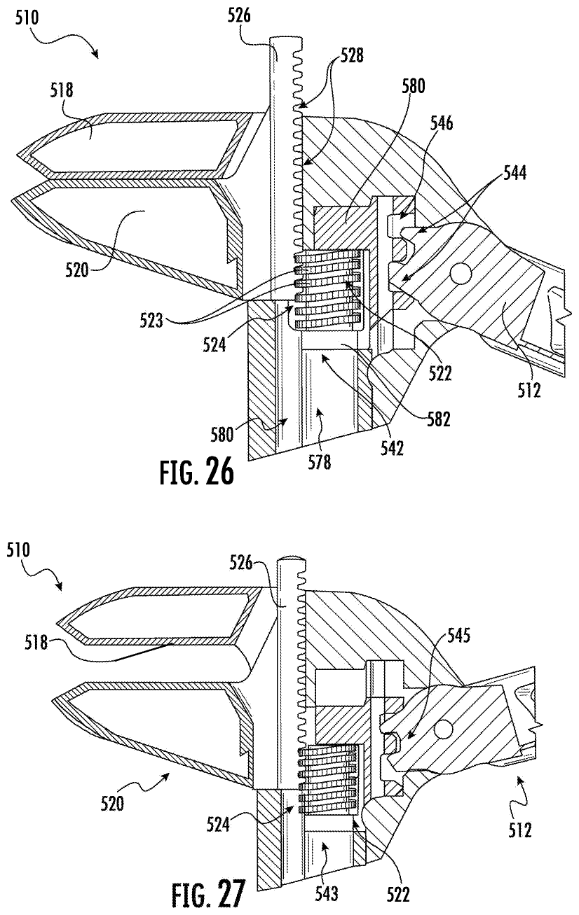

FIGS. 24 and 26 show wrench head 516 in a closed position. Adjustment mechanism 524 includes a carriage 542 that is configured to hold screw drive 522. In a specific embodiment, screw drive 522 includes a plurality of threads 523. Carriage 542 includes an upper support 580 and a lower support 582 spaced a distance from upper support 580. When wrench head 516 is assembled, screw drive 522 extends between upper support 580 and lower support 582. In various embodiments, an axle extends through the screw drive 522 between the upper support 580 and the lower support 582 of the carriage 542.

Carriage 542 is positioned within a first carriage recess 578 on wrench head 516. A second corresponding carriage recess 576 (see e.g., FIG. 23) is positioned on cover portion 574. When wrench 510 is assembled, first carriage recess 578 and second carriage recess 576 extend around and support carriage 542 and screw drive 522. A rear portion of carriage 542 that is positioned between jaw faces 519, 521 and handle 512 includes recesses 546. Recesses 546 of carriage 542 are configured to receive and engage with cams 544 of handle 512. A handle recess 545 is positioned between the cams 544 of handle 512. When carriage 542 and screw drive 522 are in a closed position, wrench head 516 is ready to apply torque to a workpiece. FIGS. 25 and 27 show wrench head 516 in an open position. In the open position there is a space defined between fixed jaw 518 and adjustable jaw 520 and a space between an uppermost surface of screw drive 522 and an upper edge 550 of an opening 548 in head 516 through which a user can see screw drive 522.

When a user places wrench 510 around a workpiece like a pipe, handle 512 can be rotated about pivot axis 530 such that cams 544 engage recesses 546 causing carriage 542 and/or screw drive 522 to move and engage with grooves 528 of projection 526 on adjustable jaw 520. This engagement between screw drive 522 and adjustable jaw 520 causes the movement or adjustment of wrench head 516. In other words, the threaded portion or plurality of grooves 528 of adjustable jaw 520 engage with screw drive 522 such that when the carriage 542 is moved or pushed down, the screw drive 522 rotates relative to the carriage moving the adjustable jaw 520 relative to the fixed jaw 518.

In other words, when handle 512 is pivoted in a first direction, a first cam 544 and second cam 544 bear against a surface of a first carriage recess 546 and a surface of a second carriage recess 546 such that carriage 542 is lifted. When handle 512 is pivoted in a second direction, opposite of the first direction, the first cam 544 and second cam 544 bear against the surface of the first carriage recess 546 and the surface of the second carriage recess 546 such that the carriage 542 is pushed down. When the handle 512 is pivoted in the first direction, at least one cam 544 engages at least one carriage recess 546 of the carriage 542 such that the screw drive 522 engages a rear portion of the adjustable jaw 520 moving the adjustable jaw 520 away from the fixed jaw 518. When the handle 512 is pivoted in the second direction, at least one cam 544 engages at least one carriage recess 546 of the carriage 542 such that the screw drive 522 engages a rear portion of the adjustable jaw 520 moving the adjustable jaw 520 toward the fixed jaw 518.

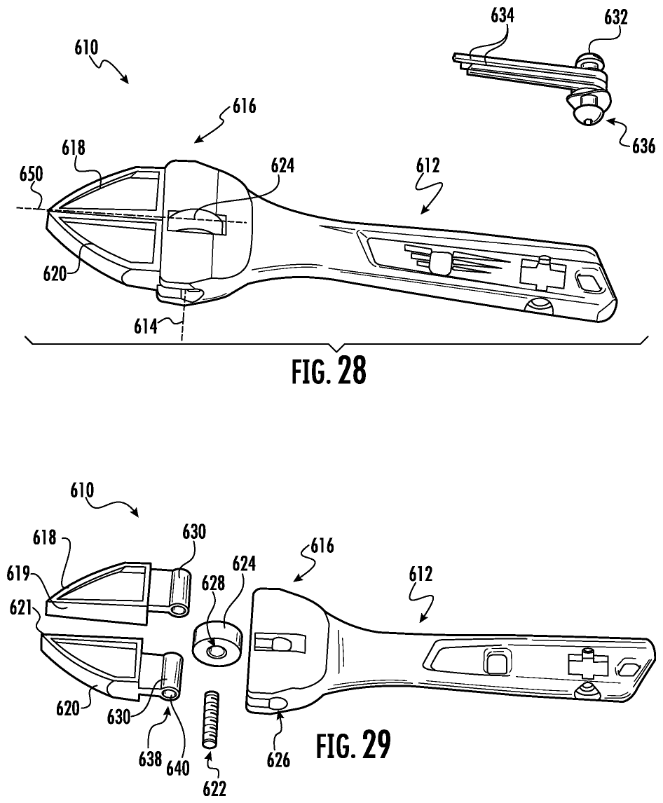

Referring to FIGS. 28-31, various views of a wrench shown as an adjustable wrench 610 are shown, according to an exemplary embodiment. Adjustable wrench 610 includes a shank or handle 612 extending from head 616. Wrench head 616 includes a first jaw 618 and a second jaw 620. In general, a drive component shown as a nut 624 is positioned at head 616 between handle 612 and jaws 618, 620 and allows the user to change the relative positions of first jaw 618 and second jaw 620. First jaw 618 includes a jaw surface or face 619 and second jaw 620 includes a jaw surface or face 621.

In a specific embodiment, a rotatable tool set 636 is coupled to handle 612. In the illustrated embodiment, tool set 636 is positioned along a longitudinal axis 650 while being stored. Tool set 636 includes a rotatable axle or pin 632. A plurality of hand tools, shown as flathead screwdrivers 634 are coupled to axle 632. Flathead screwdrivers 634 can be rotated away from the storage position for use.

A channel 626 is defined within wrench head 616 and an axis of rotation 614 of nut 624 extends through channel 626. When wrench head 616 is assembled, a threaded screw 622 couples first jaw 618, second jaw 620 and nut 624 together. Specifically, threaded screw 622 extends through a bore 638 on a connection portion 630 of each jaw 618, 620. Each bore 638 includes a threaded surface 640. Each connection portion 630 is sized and/or shaped to fit within channel 626 of wrench head 616. Additionally, threaded screw 622 is received within bore 628 of nut 624. A portion of threaded screw 622 contains left-hand threads while the opposing portion contains right-hand threads.

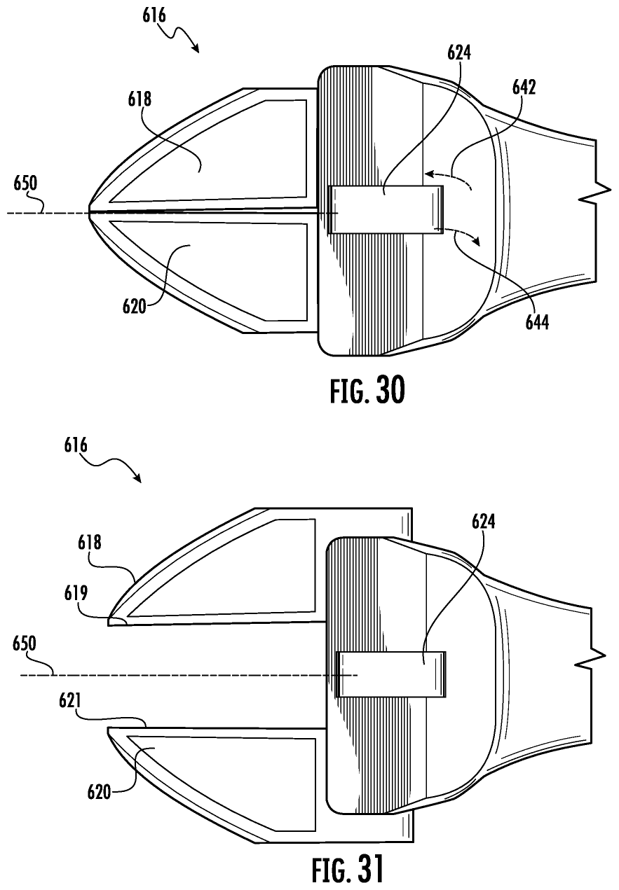

FIGS. 30-31show wrench head 616 in a closed and open position respectively. When a user rotates nut 624 in a clockwise 644 and/or counterclockwise direction 644, nut engages threaded screw 622 to move first and second jaws 618, 620 to open or close wrench head 616.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed:

1. An adjustable wrench comprising:
a handle comprising:
an engagement end; and
a gripping end, the handle extending between the gripping end and the engagement end along a longitudinal axis of the handle;
a head coupled to the engagement end of the handle, the head comprising:
a fixed jaw; and
an adjustable jaw extending away from the fixed jaw;
an adjustment mechanism positioned between engagement end of the handle and the adjustable jaw, the adjustment mechanism engages a rear portion of the adjustable jaw; and
a pivot axis, the pivot axis perpendicular to the longitudinal axis;
wherein, when the handle is pivoted about the pivot axis, the engagement end of the handle moves the adjustment mechanism such that the adjustable jaw is moved relative to the fixed jaw.

2. The adjustable wrench of claim 1, wherein the adjustment mechanism comprises:
a screw drive; and
a carriage that holds the screw drive between an upper support and a lower support, the carriage positioned between the screw drive and the engagement end of the handle.

3. The adjustable wrench of claim 2, the carriage further comprising at least one recess, the recess facing the engagement end of the handle and the engagement end of the handle further comprising at least one cam extending toward the fixed jaw.

4. The adjustable wrench of claim 3, wherein, when, the handle is pivoted in a first direction, the at least one cam engages the at least one recess of the carriage such that the screw drive engages a rear portion of the adjustable jaw moving the adjustable jaw away from the fixed jaw.

5. The adjustable wrench of claim 3, wherein, when, the handle is pivoted in a second direction, the at least one cam engages the at least one recess of the carriage such that the screw drive engages a rear portion of the adjustable jaw moving the adjustable jaw toward the fixed jaw.

6. The adjustable wrench of claim 4, the rear portion of the adjustable jaw comprising a plurality of grooves, the grooves receiving threads of the screw drive when the screw drive engages the adjustable jaw.

7. The adjustable wrench of claim 1, wherein an adjustable distance is defined between a first jaw surface of the fixed jaw and a second jaw surface of the adjustable jaw.

8. The adjustable wrench of claim 7, wherein the adjustable distance is from 0 to 2 ⅜ inches.

9. A wrench comprising:
a handle comprising:
a first end; and
a second end, the handle extending between the first end and the second end along a longitudinal axis of the handle;
a head coupled to the first end of the handle, the head comprising:
a fixed jaw comprising a first jaw face; and
a moveable jaw comprising a second jaw face, the second jaw face extending away from the first jaw face;
a screw drive engaged with the moveable jaw;
a carriage that holds the screw drive; and
a pivot axis, the pivot axis perpendicular to the longitudinal axis of the handle;
wherein, when the handle is pivoted about the pivot axis, the first end of the handle moves the screw drive such that the moveable jaw is moved relative to the fixed jaw.

10. The wrench of claim 9, the first end of the handle comprising a first cam and a second cam, wherein the first cam and the second cam extend into and engage a first carriage recess and a second carriage recess.

11. The wrench of claim 10, wherein, when the handle is pivoted in a first direction, the first cam and the second cam bear against a surface of the first carriage recess and a surface of the second carriage recess such that the carriage is lifted.

12. The wrench of claim 11, the screw drive comprising threads engaged with a projection of the moveable jaw, the projection comprising a threaded portion such that when the carriage is lifted the screw drive rotates relative to the carriage moving the moveable jaw relative to the fixed jaw.

13. The wrench of claim 12, wherein the projection of the moveable jaw extends in an orientation perpendicular to the second jaw face and grooves of the threaded portion have an orientation generally parallel to the second jaw face.

14. The wrench of claim 10, wherein, when the handle is pivoted in a second direction, the first cam and the second cam bear against a surface of the first carriage recess and a surface of the second carriage recess such that the carriage is pushed down.

15. The wrench of claim 14, the screw drive comprising threads engaged with a projection of the moveable jaw, the projection comprising a threaded portion such that when the carriage is pushed down the screw drive rotates relative to the carriage, moving the moveable jaw relative to the fixed jaw.

16. A self-adjusting wrench comprising:
a handle comprising:
an engagement end; and
a gripping end, the handle extending between the gripping end and the engagement end along a longitudinal axis of the handle;
a head coupled to the engagement end of the handle, the head comprising:
a fixed jaw; and
an adjustable jaw extending away from the fixed jaw, the adjustable jaw comprising a threaded section;
a screw drive comprising threads and engaged with the threaded section of the adjustable jaw; and
a carriage that holds the screw drive;
wherein, when the handle is pivoted, the engagement end of the handle interfaces against the carriage and rotates the screw drive such that the adjustable jaw is moved relative to the fixed jaw.

17. The self-adjusting wrench of claim 16, further comprising a torsion spring, the torsion spring engages a projection on a rear surface of the engagement end of the handle.

18. The self-adjusting wrench of claim 17, wherein, when the handle is pivoted in a downward direction, the projection of the handle compresses an arm of the torsion spring.

19. The self-adjusting wrench of claim 18, wherein, when the handle is pivoted in an upward direction, the projection releases the arm of the torsion spring.

20. The self-adjusting wrench of claim 18, wherein the torsion spring biases the handle back into a resting position after the rotation of the screw drive.
